(19) United States
(12) Patent Application Publication
(10) Pub. No.: US 2024/0016693 A1
(43) Pub. Date: Jan. 18, 2024

(54) MASSAGE CHAIR HEAT DISSIPATION STRUCTURE

(71) Applicant: Chih-Yung HSU, Tainan City (TW)

(72) Inventor: Chih-Yung HSU, Tainan City (TW)

(21) Appl. No.: 17/988,628

(22) Filed: Nov. 16, 2022

(30) Foreign Application Priority Data
Jul. 15, 2022 (TW) 111207639

(51) Int. Cl. A61H 15/00

(52) U.S. Cl. CPC A61H 15/0078; A61H 2201/0214; A61H 2201/0221; A61H 2201/0149; A61H 2203/0431; A61H 2201/1623; A61H 2205/081; A61H 2201/0207; A61H 2015/0014

(57) ABSTRACT

A massage chair heat dissipation structure, including: a massage base, having a first side and a second side, with a massage member mounted on the first side; and a fan unit, which is pivot connected to the massage base. When the massage member is massaging the human body, operation of the fan unit drives air therethrough and between the first side and the second side by flowing through a flow path, which prevents a user from having a clammy feeling, and further improves user comfort during massage.

### BACKGROUND OF THE INVENTION

### (a) Field of the Invention

The present invention relates to a massage chair, and more particularly to a massage chair heat dissipation structure.

### (b) Description of the Prior Art

In order to simulate the human hands massaging a person's back, there are currently various types of massage chair technology, which allows people to experience a relaxing massage whenever and wherever possible.

As a specific example, China Patent No. CN 215229831 U provides a massage chair structure comprising a frame with a massage head, corresponding running tracks are respectively fitted to two sides of the frame on the backrest of the massage chair, and one end of the frame rolls and is supported between the two running tracks by means of running rotating shafts. A sliding track groove is provided in each of the running tracks along the length directions thereof, crankshafts are respectively configured on the other end of the frame corresponding to the running rotating shafts, and the ends of the crankshafts are respectively slide supported inside the two corresponding sides of the sliding track grooves. When the frame moves along the running track and reaches a set position, the crankshafts rotate and drive back and forth the corresponding ends of the front and rear of the frame.

Another example includes China Patent No. CN 211610659 U, which provides a seesaw type running massage mechanism, comprising a massage mechanism, a base plate, and driving wheels and driven wheels assembled on the two ends of the base plate; wherein superposed gear wheels on the wheel sides of the aforementioned driving wheels are caused to move on gear racks by a running motive power. The utility model patent is characterized in that: at least one end of the base plate is shaped to form a C-shaped opening, and the centre portion of the base plate is angled to form a raised foot end and a flat end. The above-described driving wheels are positioned on the raised foot end, and the driven wheels are positioned on the flat end. The aforementioned massage mechanism is movable positioned on the flat end through support shafts; hence, when moving back and forth one end is able to enter the C-shaped opening of the base plate, with springs helping to maintain the initial state of the massage mechanism.

The two patents described above are indeed able to provide a massage function that enables achieving a massaging effect on the human body; however, a person's back is usually tightly pressed against the back of the massage chair during massage, which easily causes the user to experience a clammy feeling.

### SUMMARY OF THE INVENTION

According to one aspect of the present invention, a massage chair heat dissipation structure that is installed in a massage chair body, comprising: a massage base, which is configured in the massage chair body; the massage base has a first side that is close to a user's body and a second side at a distance from the user's body; moreover, a massage member is further mounted on the first side; and a fan unit, which is pivot connected to the massage base and interconnects the first side and the second side. When the massage member is massaging a user's body, operation of the fan unit drives air therethrough that flows through a flow path between the first side and the second side.

Furthermore, a displacement mechanism is installed on the massage base, and a guiding mechanism is installed in the massage chair body, wherein the displacement mechanism is joined to the guiding mechanism. The displacement mechanism drives and displaces the massage base along the guiding mechanism through the guidance of the guiding mechanism.

Further, the displacement mechanism includes a gear wheel, and the guiding mechanism comprises the gear wheel that correspondingly meshes with a gear rack.

Further, the displacement mechanism includes a roller wheel, and the guiding mechanism comprises a track that accommodates the roller wheel.

In addition, an angle is provided between the gear rack and the track.

Additionally, the massage base is installed in the chair back of the massage chair body, and the guiding mechanism corresponds to the spinal curve of a human body.

Further, an electric heating unit fitted is provided adjacent to the fan unit, whereby air is heated by the electric heating unit when flowing in the flow path.

In addition, the flow path is configured from the second side to arrive at the first side through the fan unit.

Additionally, the flow path can be configured from the first side to arrive at the second side through the fan unit.

Further, another fan unit is installed in a seat area of the massage chair body.

Further, an embodiment of the present invention is provided with an electric heating unit fitted adjacent to the other fan unit and positioned in the seat area.

Based on the above-described technological characteristics:
1. Use of the fan unit enables air to flow in the flow path between the first side and the second side, thereby preventing a user from having a clammy feeling, as well as further improving user comfort during massage.
2. Configurational use of the displacement mechanism and the guiding mechanism enables driving and displacing the massage base along the guiding mechanism through the displacement mechanism, thereby facilitating massaging different regions of a user's body.
3. Use of the gear wheel and the gear rack facilitates controlling displacement amplitude of the massage base; moreover, the functional combination of the roller wheel and the track improves displacement smoothness of the massage base.
4. Use of the angle provided between the gear rack and the track enables reducing the entire size of the massage chair heat dissipation structure.
5. Use of the guiding mechanism corresponding to the spinal curve ensures the massage member smoothly massages a person's back portion.
6. Use of the electric heating units allows a user to experience a warm feeling during winter.
7. The flow path allows air to flow from the first side to the second side or from the second side to the first side, facilitating practical configurational installation according to the form of the massage chair body.
8. Apart from the chair back, the fan unit can also be installed in the chair seat area, thereby providing the seating region with a ventilation effect.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is an application schematic view of a first embodiment of the present invention, showing a massage chair heat dissipation structure installed in the chair back of a massage chair body.

FIG. 2 is a side view of the first embodiment of the present invention.

FIG. 3 is a partial enlarged view of the first embodiment of the present invention, showing a displacement mechanism and a guiding mechanism.

FIG. 4 is an operational view of the first embodiment of the present invention, showing air flow direction.

FIG. 5 is a side view of a second embodiment of the present invention.

FIG. 6 is an operational view of the second embodiment of the present invention, showing air flow direction.

FIG. 7 is an application schematic view of a third embodiment of the present invention, showing the massage chair heat dissipation structure installed in the chair back of the massage chair body with a fan unit and an electric heating unit mounted in the seat area.

### DETAILED DESCRIPTION OF THE PREFERRED EMBODIMENTS

Based on the above-described technological characteristics, the main functions of a massage chair heat dissipation structure of the present invention are clearly presented in the following embodiments.

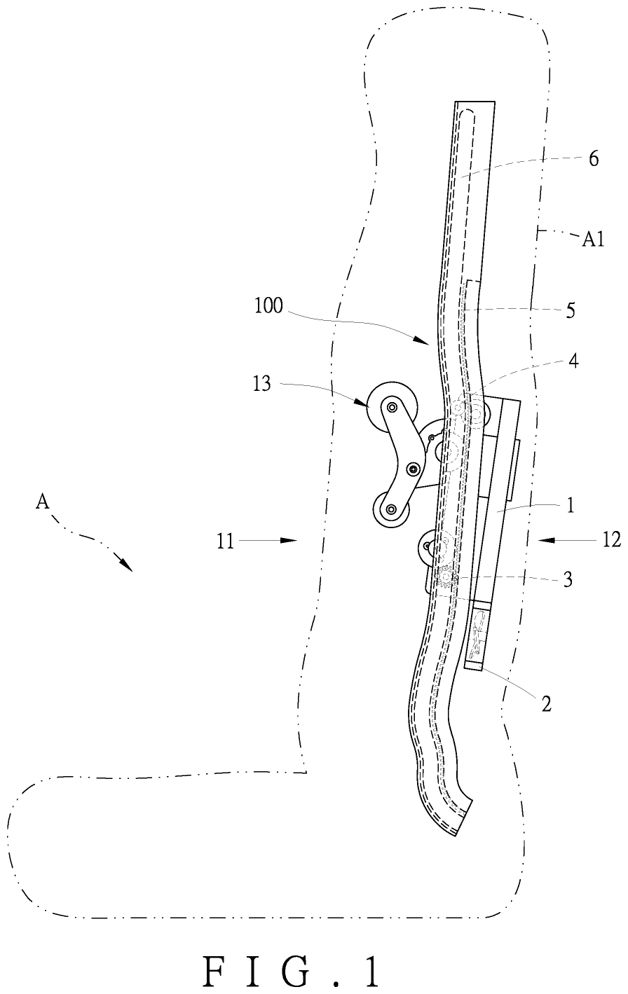

Referring first to FIGS. 1 to 3, which disclose a massage chair heat dissipation structure 100 according to the first embodiment of the present invention installed in a massage chair body A, thereby forming a massage chair.

It is preferable that the massage chair heat dissipation structure 100 is installed in a chair back A1 of the massage chair body A, thereby enabling use thereof to massage a user's back (not shown in the drawings).

Regarding the positions referred to in the following text, including upper side, lower side, left side, right side, front and rear, close to, and at a distance from; they specifically define areas based on the position of a user sitting on the massage chair.

The massage chair heat dissipation structure 100 comprises:

A massage base 1, which is installed in the massage chair body A, is further fitted with a massage member 13 installed in the first side 11 close to a user and at a distance from a second side 12 away from the user.

It is hereby specifically pointed out that the present invention is not making any improvements on the massage base 1 itself, as the massage base 1 already belongs to the prior art. Thus, any further description of the operation and structure of the massage base 1 and the massage member 13 is omitted.

A person having ordinary skill in the art should be able to setup an appropriate configuration thereof according to the selected type and form of the massage base. For example, using linkages, springs, etc., to enable controlling the massage member 13 to massage a user or repositioning the massage member 13.

In a practical embodiment, the massage base 1 can be installed in a different location in the massage chair body A, to enable massaging a user's hips, legs, hands, etc.

A fan unit 2, which is pivot connected to the massage base 1, wherein the fan unit 2 interconnects the first side 11 and the second side 12. It is preferable that the fan unit 2 is extended configured to one of the ends of the massage base 1 to prevent interfering with operation of existing components fitted to the massage base 1.

A displacement mechanism, which is installed on the massage base 1, and in the present embodiment the displacement mechanism comprises a gear wheel 3 and a roller wheel 4.

A guiding mechanism, which is installed in the massage chair body A, wherein in the present embodiment the guiding mechanism comprises a gear rack 5 and a track 6. It is preferable that the gear rack 5 and the track 6 correspond to a user's spinal curve.

The gear wheel 3 correspondingly meshes with the gear rack 5, and the track 6 accommodates the roller wheel 4, thereby enabling the gear rack 5 and the track 6 to guide the gear wheel 3 and the roller wheel 4, the movement of which drives and displaces the massage base 1 along the gear rack 5 and the track 6.

It is preferable that, in order to prevent the problem of a plurality of the teeth of the gear wheel 3 meshing with the gear rack 5, a configuration is chosen that fits the gear wheel 3 to the lower side of the massage base 1 and the roller wheel 4 to the upper side, thereby in addition to controlling displacement amplitude of the massage base 1, displacement smoothness of the massage base 1 is further improved. Moreover, appropriate control of the number of teeth on the gear wheel 3 and mutual spacing thereof enables concurrently using a plurality of the gear wheels 3 on the same gear rack 5. Accordingly, the present invention does not exclude such an embodiment mode.

In order to ensure stability of the massage base 1, the gear wheel 3 and the roller wheel 4 can be respectively mounted on the left and right sides of the massage base 1; moreover, two of the gear racks 5 and two of the tracks 6 can be correspondingly installed in the massage chair body A.

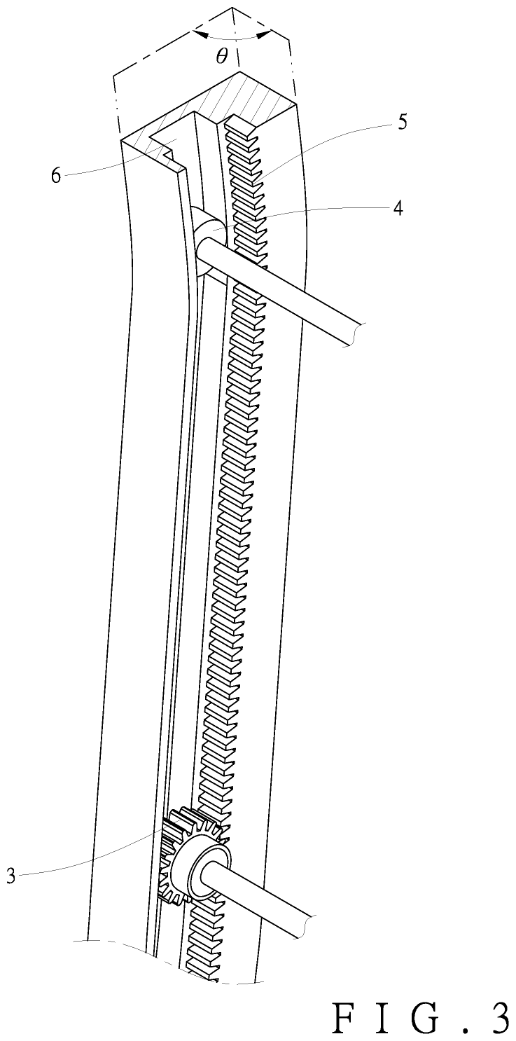

An angle θ is provided between the gear rack 5 and the track 6, for example 90 degrees, as shown in FIG. 3, to enable the axial lines of the gear wheel 3 and the roller wheel 4 to extend along the left and right sides of the massage base 1. Accordingly, an increase in the thickness of the front and rear of the massage base 1 is avoided and also the entire size of the massage chair heat dissipation structure 100 is reduced.

It is further specifically pointed out that a control unit, such as a remote control unit, can also be installed using a wired or wireless method to control operation of the massage chair components, including the massage member 13, the gear wheel 3, etc. Moreover, a power supply unit can also be fitted to supply the electric power required by the massage chair heat dissipation structure 100. However, drawings of the control unit and the power supply unit are not depicted in the figures.

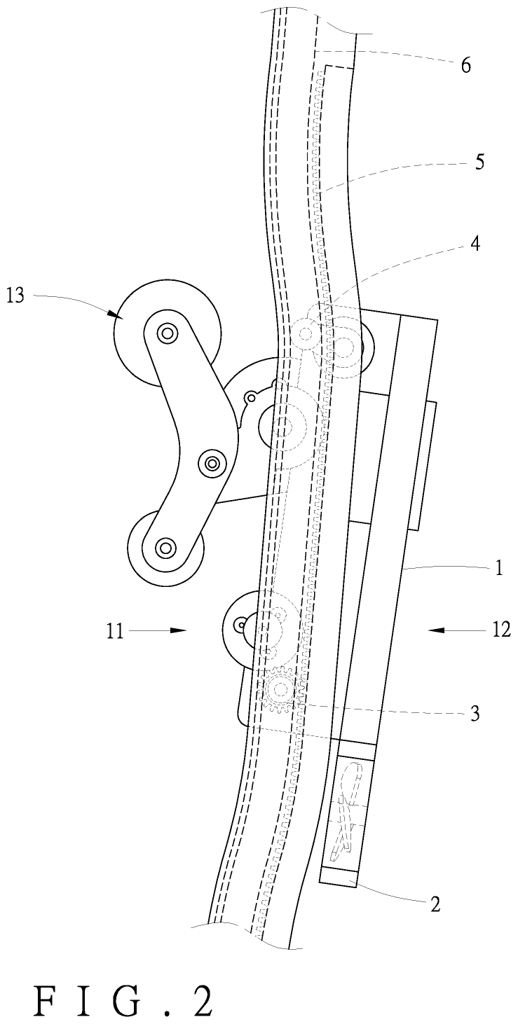

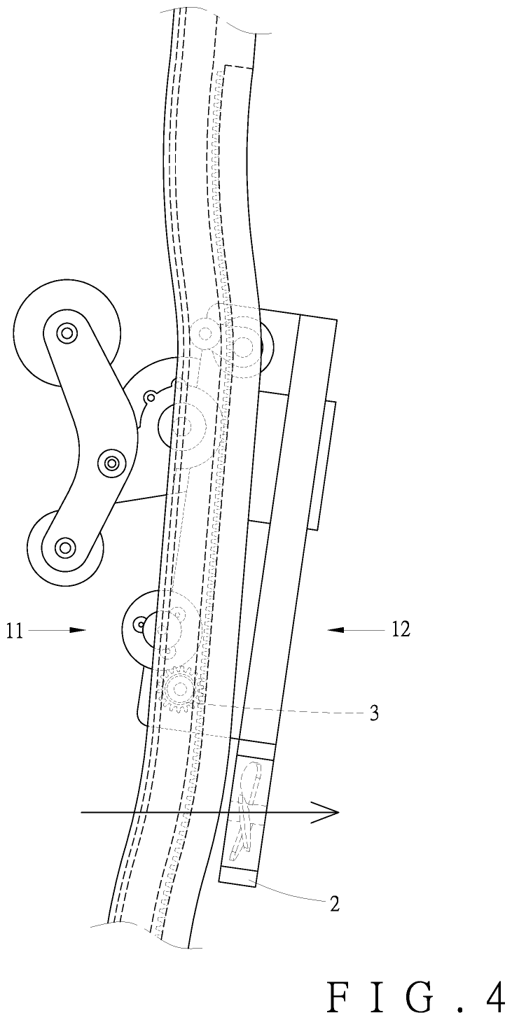

Referring to FIG. 2 and FIG. 4, the massage base 1 is driven along the gear rack 5 and the track 6 via the gear wheel 3 and the roller wheel 4 and moved to the region of the user's body requiring massage, thereby facilitating massaging different regions of the user's body.

Because the gear rack 5 and the track 6 correspond to the spinal curve of a user, the massage base 1 is assured to continue to lie close to the user's spine during movement thereof, thereby ensuring the massage member 13 smoothly massages the user's back portion.

When the massage member 13 is massaging a user, operation of the fan unit 2 drives air therethrough that flows through a flow path between the first side 11 and the second side 12.

In the present embodiment, the flow path is from the first side 11 through the fan unit 2 to arrive at the second side 12, as shown in FIG. 4. This function enables moist hot air close to a user's back portion to be carried away, and further causes a relatively drier air to surround the user and fill the area close to the user's back portion, allowing the user to experience a cool feeling.

In a practical embodiment, the flow path can also be from the second side 12 to arrive at the first side 11 through the fan unit 2. Hence, the present invention is not limited to either configuration, and a practical configuration can be installed according to the form of the massage chair body A.

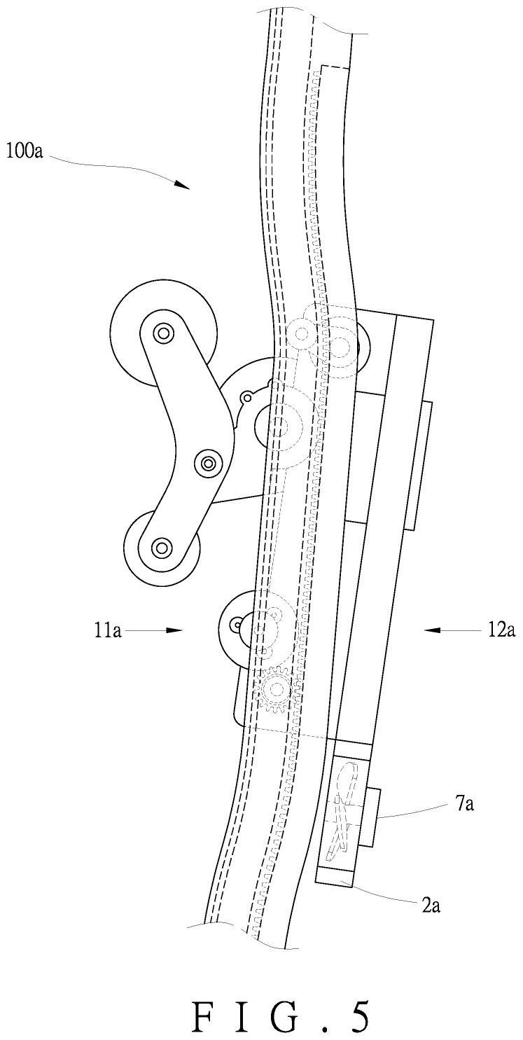

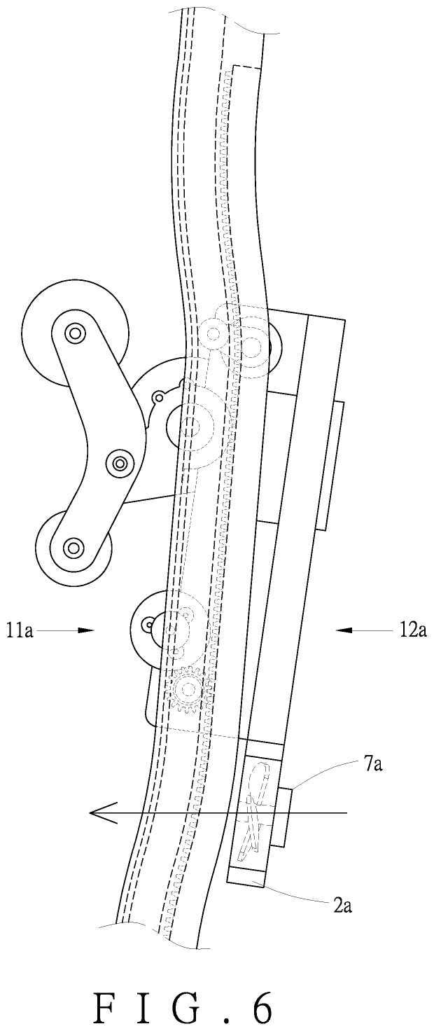

Referring to FIGS. 5 and 6, which disclose a second embodiment of the present invention, wherein the differences of a massage chair heat dissipation structure 100a of the second embodiment with the first embodiment lie in the second embodiment further comprising an electric heating unit 7a installed adjacent to a fan unit 2a, whereby air is heated by the electric heating unit 7a when flowing in the flow path.

It is preferable that the flow path is from a second side 12a to arrive at a first side 11 a through the fan unit 2a, as shown in FIG. 6. During winter or in cold weather, such a configuration provides a user's back portion with a warm air flow, as well as dispersing the relatively cold air close to the user's back portion, thus allowing the user to experience a warm feeling.

The remaining structure and operation of the massage chair heat dissipation structure 100a are identical to the first embodiment, and thus not further detailed herein.

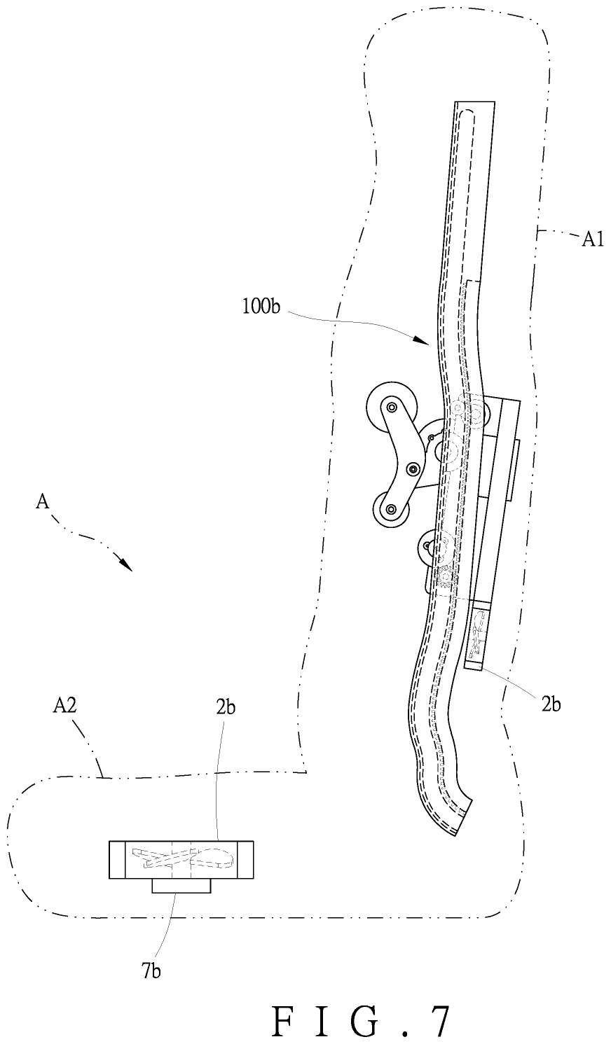

Referring to FIG. 7, which discloses a third embodiment of the present invention, wherein the differences of a massage chair heat dissipation structure 100b of the third embodiment with the first embodiment lie in:

In the first embodiment, (please refer to FIG. 1) the fan unit 2 is only installed in the chair back A1 of the massage chair body A, whereas in the third embodiment, apart from a fan unit 2b being installed to the chair back A1 of the massage chair body A, another fan unit 2b is also installed in a seat area A2 of the massage chair body A, providing the seat area A2 with a ventilation effect.

In addition to the other fan unit 2b, similar to the second embodiment, the third embodiment can have electric heating units 7b respectively contiguous installed close to the two fan units 2b, thereby allowing a user to experience a more warmer air flow close to the chair back A1 and the seat area A2, However, in FIG. 7, the electric heating unit 7b is only shown to be fitted in the seat area A2 to exemplify the configuration thereof.

Referring again to FIGS. 2 and 5, air is caused to flow between the first sides 11, 11 a and the second sides 12, 12a via the fan units 2, 2a, thus preventing the user from having a clammy feeling, and further improving user comfort during massage.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A massage chair heat dissipation structure being installed in a massage chair body, wherein the massage chair heat dissipation structure comprises:
a massage base, which is installed in a massage chair body, the massage base has a first side that is close to a human body and a second side at a distance from the human body, together with a massage member mounted on the first side; and
a fan unit, which is pivot connected to the massage base, the fan unit interconnects the first side and the second side;
when the massage member is massaging the human body, operation of the fan unit drives air therethrough that flows through a flow path between the first side and the second side.

2. The massage chair heat dissipation structure according to claim 1, wherein a displacement mechanism is further installed on the massage base, and a guiding mechanism is installed in the massage chair body; the displacement mechanism is joined to the guiding mechanism, and the displacement mechanism drives and displaces the massage base along the guiding mechanism through the guidance of the guiding mechanism.

3. The massage chair heat dissipation structure according to claim 2, wherein the displacement mechanism further includes a gear wheel, and the guiding mechanism includes the gear wheel that correspondingly meshes with a gear rack.

4. The massage chair heat dissipation structure according to claim 3, wherein the displacement mechanism further includes a roller wheel, and the guiding mechanism includes a track that accommodates the roller wheel.

5. The massage chair heat dissipation structure according to claim 4, wherein an angle is provided between the gear rack and the track.

6. The massage chair heat dissipation structure according to claim 2, wherein the massage base is installed in the chair back of the massage chair body, and the guiding mechanism corresponds to the spinal curve of the human body.

7. The massage chair heat dissipation structure according to claim 1, wherein an electric heating unit is further fitted adjacent to the fan unit, whereby air is heated by the electric heating unit when flowing in the flow path.

8. The massage chair heat dissipation structure according to claim 1, wherein the flow path is configured from the second side to arrive at the first side through the fan unit.

9. The massage chair heat dissipation structure according to claim 1, wherein the flow path is configured from the first side to arrive at the second side through the fan unit.

10. The massage chair heat dissipation structure according to claim 1, wherein another fan unit is installed in a seat area of the massage chair body.

11. The massage chair heat dissipation structure according to claim 10, wherein another electric heating unit is additionally fitted adjacent to the other fan unit and positioned in the seat area.
